(19) United States
(12) Patent Application Publication
(10) Pub. No.: US 2017/0306694 A1
(43) Pub. Date: Oct. 26, 2017

(54) RESTRICTION MEMBER FOR PLEATED SHADE ASSEMBLIES

(71) Applicant: CHING FENG HOME FASHIONS CO., LTD., Fuxing Shiang (TW)

(72) Inventors: SHENG YING HSU, Fuxing Shiang (TW); CHUN JAN HSU, Fuxing Shiang (TW)

(21) Appl. No.: 15/461,411

(22) Filed: Mar. 16, 2017

(30) Foreign Application Priority Data
Apr. 25, 2016 (TW) 105204331

(51) Int. Cl. E06B 9/262; E06B 9/386

(52) U.S. Cl. CPC E06B 9/262; E06B 9/386; E06B 2009/2622; E06B 2009/2627; E06B 2009/2625

(57) ABSTRACT

A pleated shade assembly includes a shade having multiple pleated portions formed transversely formed on the front side thereof. Any two of the pleated portions adjacent to each other have an overlapped portion which is a combination of two respective longitudinal sides of the adjacent pleated portions. A restriction member is located at the rear side of the shade and connected between the top and the bottom of the shade. The restriction member restricts expansion of the pleated portions so as to prevent the pleated portions from being overly deformed.

### BACKGROUND OF THE INVENTION

### 1. Fields of the Invention

The present invention relates to a pleated shade assembly, and more particularly, to a restriction member for controlling the expansion level of each pleated portions of the pleated shade assembly.

### 2. Descriptions of Related Art

There are many different shades developed, and one of the conventional pleated shade assemblies comprises a shade with multiple pleated portions which are continuously connected to each other and are made by non-woven material or other plastic thin plates. By the pleated portions, the pleated shade assembly can be folded in an organized way. The conventional pleated shade assemblies do not occupy too much area of the windows and also disclose the beauty of the material and the patterns.

However, when expanding the pleated shade assemblies, the pleated portions tend to expand too much due to gravity. The lower the pleated portions are located, the longer expanding distance the pleated portions expand. After a period of time of use, the pleated portions become more and more flatted and the beauty of pleated portion will disappear. Once the pleated portions are expanded without any restriction, the total length of the pleated shade assembly becomes longer and longer.

The present invention intends to provide a restriction member of a pleated shade assembly so as to prevent the pleated portions from being overly deformed.

### SUMMARY OF THE INVENTION

The present invention relates to a pleated shade assembly and comprises a shade having multiple pleated portions formed transversely formed on the front side thereof. Any two of the pleated portions adjacent to each other have an overlapped portion which is a combination of two respective longitudinal sides of the adjacent pleated portions. A restriction member is located at the rear side of the shade and connected between the top and the bottom of the shade. The restriction member restricts expansion of the pleated portions so as to prevent the pleated portions from being overly deformed.

Preferably, the each of the overlapped portions has holes. The pleated shade assembly has wires which extend from the top rail of the pleated shade assembly and extend through the holes of the overlapped portions.

Preferably, the restriction member is sewed to the overlapped portions.

Preferably, each of the overlapped portions has holes, and the pleated shade assembly has wires which extend from the top rail of the pleated shade assembly and extend through the holes of the overlapped portions. The restriction member is sewed to the overlapped portions. The wires are located between the overlapped portions and the restriction member, and hidden by the overlapped portions and the restriction member.

Preferably, a decorative pleated portion is connected behind each of the pleated portions.

Preferably, each of the decorative pleated portions is pleated relative to the pleated portion corresponding thereto and is secured to the overlapped portions.

The present invention has the advantages which are that the shade is a piece of fabric and the pleated portions are formed to the shade. The restriction member is located on the rear side of the shade and the length of the restriction member restricts the expansion of the pleated portions. By the restriction member on the rear side of the shade, the expansion of the pleated portions is restricted so that the pleated portions are not overly deformed due to gravity, such that the appearance of the shade is maintained as expected.

The restriction member provided by the present invention is able to be used on Roman shades.

The restriction member is secured to the overlapped portions so that the structure of the pleated shade assembly needs not to be changed too much to save the cost.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the pleated shade assembly of the present invention;

FIG. 2 shows a side view wherein the pleated shade assembly of the present invention is expanded;

FIG. 3 shows a side view wherein the pleated shade assembly of the present invention is folded;

FIG. 4 shows a perspective view wherein the pleated shade assembly of the present invention is folded, and

FIG. 5 shows that the pleated shade assembly of the present invention is used to a Roman shade.

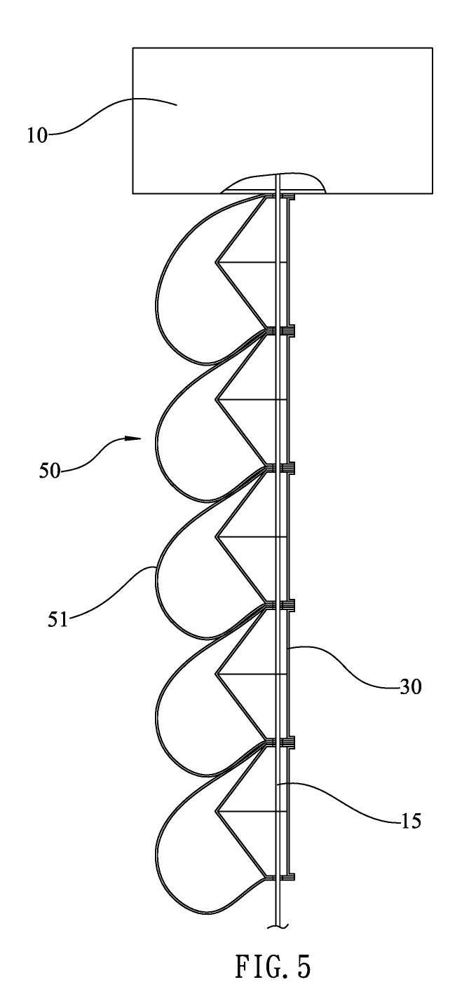

### DETAILED DESCRIPTION OF THE PREFERRED EMBODIMENT

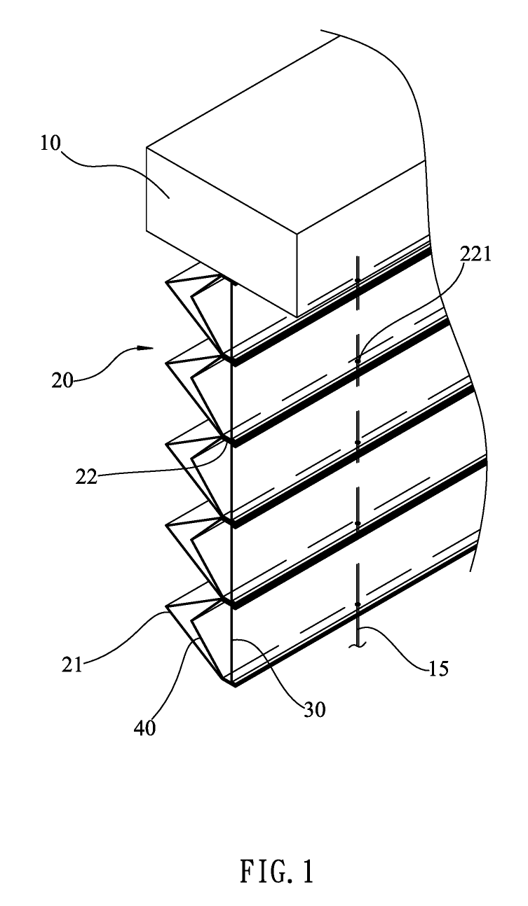

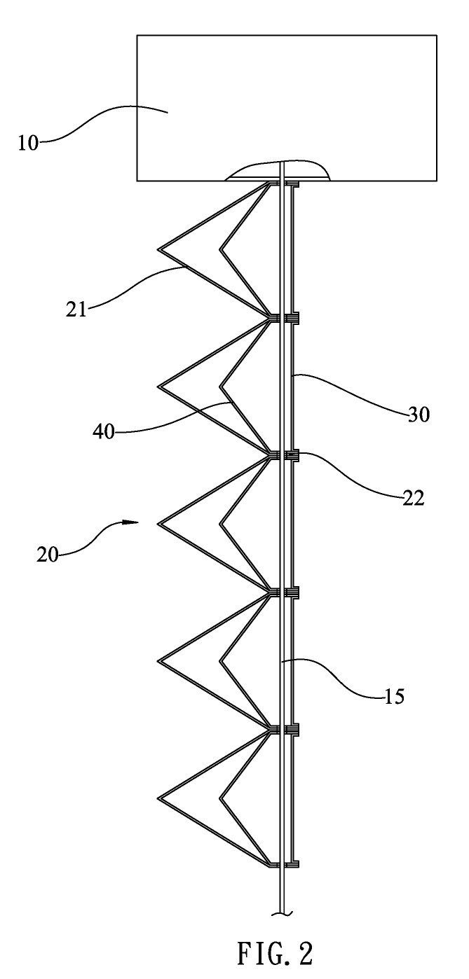

Referring to FIGS. 1 and 2, the pleated shade assembly of the present invention comprises a top rail 10 and a shade 20. The shade 20 is made of non-woven material or a plastic thin plate, multiple pleated portions 21 are continuously formed transversely formed on the front side thereof. Any two of the pleated portions 21 adjacent to each other have an overlapped portion 22 which is a horizontal portion and is a combination of two respective longitudinal sides of the adjacent pleated portions 21. Each of the overlapped portions 22 has holes 221 defined therethrough. Wires 15 extending from the top rail 10 of the pleated shade assembly extend through the holes 15 of the overlapped portions 22 so that when the wires 15 are pulled upward, the pleated portions 21 are folded one by one. The wires 15 cannot be seen from the front side of the shade 20.

A restriction member 30 is located at the rear side of the shade 20 and connected between the top and the bottom of the shade 20. The restriction member 30 is made by the same material as the shade 20. The restriction member 30 is sewed to the overlapped portions 22. The wires 15 cannot be seen from the rear side of the shade 20 because of the restriction member 30. Therefore, the wires 15 are not likely pulled out by kids. The restriction member 30 restricts expansion of the pleated portions 21. In other words, the expansion of the pleated portions 21 is restricted by the length of the restriction member 30.

A decorative pleated portion 40 is connected behind each of the pleated portions 21. Each of the decorative pleated portions 40 is pleated relative to the pleated portion 21 corresponding thereto and is secured to the overlapped portions 22. In other words, the shape of the decorative pleated portions 40 is similar to the pleated portions 21. When viewed from either side of the pleated shade assembly, there are two layers which are the pleated portions 21 and the decorative pleated portions 40.

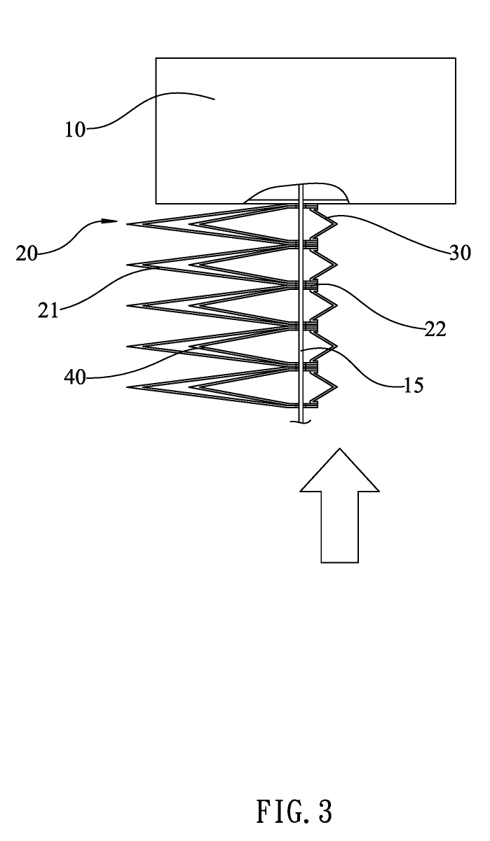

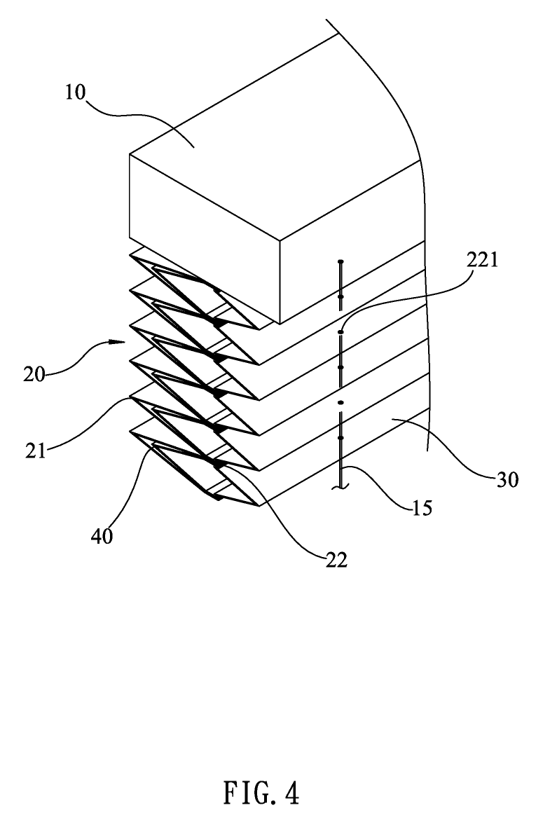

As shown in FIGS. 3 and 4, when folding the shade 20, the pleated portions 21 and the decorative pleated portions 40 are folded in sequence. The length of the restriction member 30 is shortened along with the folding action is processing. When expanding the shade 20, as shown in FIGS. 1 and 2, the pleated portions 21 and the decorative pleated portions 40 are expanded in sequence. The length of the restriction member 30 is increased along with the expanding action is processing. The length of restriction member 30 restricts the level of expansion of the pleated portions 21 which are not overly expanded.

As shown in FIG. 6, the present invention can also be used for Roman Shades 50 which have multiple shades 51. In order to prevent the shades 51 to be overly deformed due to gravity when expanding the Roman shade 50, a restriction member 30 is connected to the rear side of the Roman shade 50, the length of restriction member 30 restricts the level of expansion of the shades 51.

While we have shown and described the embodiment in accordance with the present invention, it should be clear to those skilled in the art that further embodiments may be made without departing from the scope of the present invention.

What is claimed is:

1. A pleated shade assembly comprising:
a shade having multiple pleated portions formed transversely formed on a front side thereof, any two of the pleated portions adjacent to each other having an overlapped portion which is a combination of two respective longitudinal sides of the adjacent pleated portions, and
a restriction member located at a rear side of the shade and connected between a top and a bottom of the shade, the restriction member restricting expansion of the pleated portions.

2. The pleated shade assembly as claimed in claim 1, wherein each of the overlapped portions has holes, wires extending from a top rail of the pleated shade assembly extend through the holes of the overlapped portions.

3. The pleated shade assembly as claimed in claim 1, wherein the restriction member is sewed to the overlapped portions.

4. The pleated shade assembly as claimed in claim 1, wherein each of the overlapped portions has holes, wires extending from a top rail of the pleated shade assembly extend through the holes of the overlapped portions, the restriction member is sewed to the overlapped portions, the wires are located between the overlapped portions and the restriction member, and hidden by the overlapped portions and the restriction member.

5. The pleated shade assembly as claimed in claim 1, wherein a decorative pleated portion is connected behind each of the pleated portions.

6. The pleated shade assembly as claimed in claim 5, wherein each of the decorative pleated portions is pleated relative to the pleated portion corresponding thereto and is secured to the overlapped portions.
